(19) United States
(12) Patent Application Publication
(10) Pub. No.: US 2010/0217839 A1
(43) Pub. Date: Aug. 26, 2010

(54) DEVELOPMENT SYSTEM, SERVER OF DEVELOPMENT SYSTEM, AND DEVELOPMENT METHOD

(76) Inventors: Hiroshi Kawabe, Mie (JP); Toshiharu Nishiwaki, Mie (JP); Yoshikatsu Ohtani, Mie (JP)

Correspondence Address: BIRCH STEWART KOLASCH & BIRCH, PO BOX 747, FALLS CHURCH, VA, 22040-0747, US

(21) Appl. No.: 12/599,156

(22) PCT Filed: May 2, 2008
(86) PCT No.: PCT/JP2008/058407

§ 371 Date: Nov. 6, 2009

(30) Foreign Application Priority Data
May 7, 2007 (JP) 2007-122503

(51) Int. Cl. G06F 9/45; G06F 9/44; G06F 15/16

(52) U.S. Cl. 709/219; 717/140; 717/125; 717/122; 717/163

(57) ABSTRACT

Problem to be solved is the development system of the Integrated Development Environment which can be used by a server terminal system.

Means for Solution is that a development system which develops software in a network server and a terminal, and the server and the terminal are provided. The server is provided with a library source database which can make a fixed source file and a source file preparer. Also, a compiler making an executable file from a fixed source file, and a network connecter transmitting and receiving a source file and the executable file are provided. The terminal is provided with a network connecter and an Integrated development environment which can edit and transmit a source file transmitted from the server by the network connecter of the terminal.

### FIELD OF THE INVENTION

The present invention relates to a development system of software which operates on a computer connected to a network, especially, a development system, and a server of a development system, and a development method.

### BACKGROUND OF THE INVENTION

In recent years, advance of introducing IT (information technology) for a company, a computer and software executed on the computer are used in various companies.

For example, software is used for business, accounting, etc., for the company.

As the software used in a company, commercial software arranged to way of general business and accounting may be used.

On the other hand, since the function and specification needed for each company differ from each other, the customized software, that means making software development with adjusting a setup and design of the software, according to the needs of a company may be used.

Since the demand of the dedicated software which is the customized software is extremely high, many development companies which especially developing the software exist.

Actually, a process of a development company carrying out software development in development of dedicated software is

1. Offer a commission from a Ordered Company.

2. Show Specification of Software to the Company.

3. Get Instructions of Correction from the Company.

4. Actually Perform Software Development and Get the Company to Use it.

3. Get Instructions of Correction from Company.

5. Correct the Software.

6. Completion

In many cases, it is carried out by the flowing.

In such software development, for example, the Visual Basic (registered trademark) language by using on Visual Studio (registered trademark), which is a development tool by Microsoft Corp., is employed as well.

Visual Studio (registered trademark) is a software with high functionality, a function to perform version control in a case of developing advanced and large-scale software can be called, and it is enabled to develop a software so-called for “embedded,” such as a cellular phone, However, since this Visual Studio is too highly functional, high skill of a Software Design and Development Engineer is required, there is a problem that it is necessary to spend a effort on construction of development environment in case of developing by a lot of people.

Therefore, many “models” of the program adjusted with the needs which a company request is prepared beforehand, and the development tool, which develops software based on that, exists.

For example, as refer to the patent documents 1, the development system which specialized in application also exists (hereafter, this is called as the conventional technology 1). In the development system of the conventional technology 1, a client connected on intranet or internet and a server in which the model is stored are connected.

The developer who develops dedicated software can operate a client and can develop dedicated software easily by using the model on the server.

Because the development can be performed only by calling the function connected to the server on the network by the client, there is an advantage that software development is possible in always the same environment.

Accordingly the expense to final development of software can be reduced, and it becomes enabled to lower cost.

[Patent documents 1] JP-A-2002-229786

### DISCLOSURE OF THE INVENTION

### Problems to be Solved by the Invention

However, in a development system of the conventional technology 1, there was a problem that a user interface for operating from the client was simple “wizard form” (a user interface which replies to a question interactively is simple). Actually, in a process of software development, human-induced cost, such as visiting the company directly because of receiving instructions or correction for an order from the company, and showing developed software and specifications are actually by using a lot of e-mails has extremely needed.

Since a development tool of the conventional technology 1 had the user interface by which wizard form was fixed, a process to modify about the prepared soft in response to instructions from the company was required, and there was a problem that it was difficult to reduce human-induced cost similarly.

The present invention is achieved in view of such a situation, and makes it a subject to cancel an above-mentioned subject.

### Means for Solving the Problems

A development system of the present invention is a development system which develops software which is an executable file of a source program and this source program in a network server and a terminal, a library source database which memorizes a general-purpose source file which is a file of a source program with the general-purpose server, a compiler to prepare an executable file from a source file which corrected the general-purpose source file, a network connecter which transmits and receives the source file and the executable file between the server and the terminal, a source file preparer which combines source files in general from a library source database is provided, and the terminal is provided with a network connecter connected with the server via a network, and an Integrated development environment which can edit the general-purpose source file transmitted by the network connecter of the terminal from the server, and can transmit.

A development system of the present invention includes a source file editor by which the Integrated Development Environment method can edit the general-purpose source file, and a debugger which debugs the source file based on the executable file received from the server.

A development system of the present invention is that the source file includes a common file method to process a cap of a program, a windowing method to process because of preparing a window, and a listeners class method containing source code which processes a component in the window.

A development system of the present invention can correct only the source code of the listeners class method at the terminal.

A development system of the present invention is that the server is further provided with version controller, which manage information about renewal of the source file and the executable file.

A development system of the present invention is further provided with a user relation processing method to transmit and receive information between the terminals in which the server has accessed the server.

A development system of the present invention is further provided with an OS method for thin clients by which the terminal accesses the server by OS for thin clients.

A development system of the present invention is further provided with a desktop screen method by which the server can call the executable file, and the terminal can receive the desktop screen method, and can transmit an execute command.

A server of a development system of the present invention is a server of a development system, which develops software being an executable file of a source program and this source program in a network server and a terminal, a library source database which has memorized a general-purpose source file which is a file of a general-purpose source program, a compile method to prepare an executable file from a source file which corrected the general-purpose source file, a network connecter which transmits and receives the source file and the executable file between the server and the terminal, and a source file preparer which combines a general-purpose source file from a library source database are provided.

A development method of the present invention is a development method which develops software in a network server and a terminal, the server prepares source files in general, the server transmits the source files in general to the terminal, the terminal corrects the received source files in general by an Integrated Development Environment, and a corrected source file is prepared, the terminal transmits a source file corrected to the server, the server prepares an executable file from a source file corrected, the server prepares a desktop screen which can call the executable file from the terminal, and the server respond a call of the terminal and transmits the desktop screen to the terminal.

### ADVANTAGES OF THE INVENTION

According to the present invention, a development system connected to a network and reduce human-induced cost in software development can be provided.

### BEST MODE OF CARRYING OUT THE INVENTION

### Embodiment

### Conceptual Diagram

Hereafter, with reference to drawings, the software development system related to an embodiment of the invention is explained.

FIG. 1 is a conceptual diagram of the server thin client system for executing the software development system related to an embodiment of the invention.

The server thin client system X related to an embodiment of the invention is connected with a server 10 operating the program for servers of the software development system related to an embodiment of the invention and OS for servers, such as the Windows (registered trademark) server 2003 and Linux (registered trademark,) a terminal 20-1-20-n which are PCs, such as a common PC/AT compatible machine, etc., which a software development person and the customer of dedicated software are used, via a network part 5 which is the internet, intranet, etc.

### (Configuration of a Server)

FIG. 2 is a block diagram showing the configuration of the server 10 related to an embodiment of the invention.

The server 10 is, for example, a cluster of the server, etc., comprising a plurality of servers provided with functions, such as a PC/AT compatible machine, which built-in HDD of each server is connected by using NFS (network file system,) etc., and it can be used in order that a user may connect with one server.

Also, database engine, such as MySQL (registered trademark) and PostgreSQL, is executed.

Main components of the server 10 are comprised: the controller 101 which is a control device, such as CPU; a compile process part 102 (compiler) which compiles source code prepared by a user with the development system to an executable file which can execute; a user storage part 103 which memorizes the user's home directory, a configuration file, etc., for every user; a temporary file storage part 104 which memorizes a temporary file of compilation time, etc.; a library binary database 105 which memorizes the executable file of the library (common file) of a development system, etc.; similarly, a library source database 106 which memorizes the source file of the library of a development system; a network connection part 107 (network connecter) which connects with a network, such as LAN, wireless LAN, etc.; a user interface part 108 which is used for a configuration for a file about OS for thin clients on a terminal, a user's desktop screen, etc.; a source file preparing part 109 (source file preparer) which produces a general-purpose source file from a library source database; a treating part between users 110 (user relation processor) which performs communication processing among other users, such as an E-mail, BBS (bulletin board system), a chat, a voice chat, etc.; and a version control part 111 (version controller) which manages information about renewal of a source file and an executable file.

### (Configuration of a Terminal)

FIG. 3 is a block diagram showing a configuration of the terminal 20-1 which is one of the terminals of these related to an embodiment of the invention, and this is a usual PC.

Although the terminal 20-1 is PC provided with a function of a PC/AT compatible machine, for example, it may be a thin client which has an essential function by assembled with a PC/AT compatible machine from general-purpose parts and is not the exclusive design.

As a configuration, the terminal 20-1 includes: a controller 21 which is a controller of PC and is a CPU (central processing unit), such as Intel's Core2 (registered trademark), for example; a main memory part 22 which is DRAM etc.; a chip set 23 which is an integrated circuit which performs as a memory controller exchanged for performing read/write of a memory content between the main memory part 22 and the controller 21 and executes I/O control, etc.; a hard disk unit 25 which is a hard disk drive (HDD) etc.; and a network connection part 27. Further, the chip set 23 is connected to the pointing device 45, which is the keyboard 40, a mouse, etc., and is a input part for a user to operate a PC.

A video card 26 is a part used for displaying for PC.

A display 50 which is a CRT display, a liquid crystal display, etc., is connected to this video card 26.

A network connection part 27 (network connecter) is an interface of LAN, such as a LAN card, or wireless LAN, and can connect the terminal 20-1 to a network such as Internet.

### (Starting of Os for Thin Clients)

Here, it is explained that the terminal 20-1 is used as a terminal which software developer A uses, and the terminal 20-2 is used as a terminal which a customer B of dedicated software uses.

Firstly, as a software development system related to an embodiment of the invention starts after inserting a memory medium, which is memorized the OS for thin clients (OS for thin clients processor) which enables the usual PC to be used for a thin client, to a PC of a terminal, for example, in the optical disk unit 24.

(This OS for thin clients may be memorized in the hard disk unit 25 of the terminal 20-1, or it may be started from a flash memory, etc., of USB connections, which is not illustrated).

As for this OS for thin clients, a code which identifies an owner of the memory medium is memorized in the memory medium, and it can be used without performing pass word authentication, etc., by the terminal.

Communication between the server 10, and the terminal 20-1-terminal 20-n is performed with encrypting, such as SSL, etc.

As refer to FIG. 4, which is the screen shot of this OS for thin clients being started, it is explained.

The user storage part 103 of the server 10 memorizes a series of file groups which comprise a desktop screen for every user.

For example, for every user, the server 10 memorizes a desktop.xml file (desktop screen drawer,) such as a XML form.

After a terminal starts, the server 10 transmits this desktop.xml file towards the started terminal.

When the terminal 20-1 or the terminal 20-2 starts, the display 50 of these terminals uses a Flash (registered trademark) player made by Adobe Systems, etc., and displays each user's desktop screen based on desktop.xml which is data comprising the above-mentioned desktop screen transmitted from the server 10.

When a user uses pointing device 45, etc., and an operation, such as a click, a double click, a drug, to an icon is performed on the desktop screen, the controller 21 of the terminal reflects on a screen of the display 50.

Moreover, a corresponding command about the operation is transmitted to the server 10 from the network connection part 27 via the network part 5.

The controller 101 of the server 10 produces desktop.xml which comprises a desktop screen corresponding to a command received from the network connection part 107, and then outputs it to the terminal 20-1 or 20-2 from the network connection part 107 via the network part 5.

The network connection part 27 of the terminal receives this desktop.xml, and the controller 21 memorizes it to the main memory part 22.

Based on this memorized data, the controller 21 updates a desktop screen and outputs it on a screen of the display 50. As an operation, which the user can experience in the terminal 20-1 or 22-2, it is similar to that of Windows (registered trademark) which is a versatile OS, and, by a double click of an icon on the desktop screen, a program relevant to the icon will be executed.

In this case, a program relevant to the icon memorized in the user storage part 103 of the server 10 is downloaded according to the above-mentioned process to the terminal 20-1 or 20-2, and the controller 21 of the terminal 20-1 or 20-2 executes it.

### (Starting of a Software Development Tool)

Then, a configuration of a software development system related to an embodiment of the invention is explained with reference to drawings.

When a dedicated software development tool (Integrated development environment) applied to an embodiment of the invention in FIG. 4 is started, Software developer A inputs an execute command, such as double-clicking by the pointing device 45 to the icon 200 which is the “Ukiyoe” icon on a desktop screen.

An above-mentioned process accordingly, a program for terminals of a dedicated software development tool, which is held in a base directory of a development tool which is not illustrated and is included in the library binary database 105 and/or the library source database 106 of the server 10, is downloaded to the terminal 20-1 and is executed.

Various configuration files are also included in the base directory, and these are simultaneously downloaded to the terminal 20-1.

As the configuration files, for example, there is a “componentlist.xml,” etc., for describing a list of a “component” for a user to write a source code with a dedicated software development tool.

As this componentlist.xml, for example, the following codes can be used.

```
<component-list image-dir=“images”>
    <basic>
        <component  name=“notation”  available=“true”
    image=“notation.jpg” tool-tip=“Notation” />
    </basic>
    <custom>
    </custom>
</component-list>
```

Then, the controller 101 of the server 10 refers to a user's home directory and see the user produces a configuration file for custom components as described later.

The user's home directory is a home directory about “/users/(group ID)/(user ID)” in a default setting. For example, when group ID of software developer A is set to “dev” and user ID is made into “user_a”, a home directory of software developer A serves as “/users/dev/user_a.”

As a configuration file for custom components, a user makes a configuration file as components/components.xml directly under a home directory, and it attains a function equivalent to above-mentioned componentlist.xml.

When software developer A does not make this components.xml file or when it does not exist in case of a user having deleted, etc., the server 10 does not read it at a start-up.

When a user has made a components.xml file, the controller 101 of the server 10 transmits it to the terminal 20-1 in the similar manner above-mentioned componentlist.xml.

Since a multi window system is used for a desktop screen of OS for thin clients, a dedicated software development tool is displayed by above-mentioned process on a desktop screen in a type of a window.

This dedicated software development tool can perform software development with high pliability and high development efficiency by an Integrated Development Environment of GUI (graphical user interface).

On this window, software developer A can use a various function of a development system for developing a program which will be made a dedicated software.

A definite procedure in case that software developer A uses this software development tool is explained.

Firstly, software developer A creates a “project” which is a collection of source codes, which is a foundation of dedicated software, on the started dedicated software development tool.

Besides, the user edits the present source code properly and describes a customized program.

After description finishes, software developer A carries out a compile process to be generated an executable file.

Software developer A can also be debugged by corresponding a source code and an executable file.

A process until: getting the customer B checked about an executable file made in a server, receiving a request for revision, editing the source code, and making makes an executable file again, are enabled to carry out promptly.

An executable file completed thoroughly can be immediately used for the customer B by only copying it within a server without a need to work about installation, etc.

### (Program Language of a Development System)

As program language for a program developed with this development system, a source code of haXe (http://haxe.org) which is a compatible script of Action Script 3.0 drawn up a standard by Adobe and Action Script 3.0 can be produced.

In addition, for example, AsWing (http://www.aswing.org/) can be used as a component library for these source codes.

Also, an executable file (.swf file) of Flash can be made by carrying out compile a source file written a source code as mentioned above which describes later on the server 10. Also, an executable file of Flash can be debugged with a development tool on the terminal 20-1-20-n.

Further, an executable file of Flash has the feature that it does not only enable to execute on a desktop screen of OS for thin clients, but it does execute by itself as general-purpose, for example, in web browsers, such as Windows (registered trademark), Mac OS (registered trademark), i-mode (registered trademark), etc.

Thereby, a program which does not dependent on a platform of a user of a dedicated software can be developed.

Furthermore, not only Flash can be developed with a development system related to an embodiment of the invention, but also, for example, enables to develop a program of the other program language, such as C++ and JAVA (registered trademark).

### (API of the Development System)

As an object group being as API (application programming interface,) which can be used by the development, on program language, “jp.ize.sharaku.common” (API about login processing of OS for thin clients, etc.), “jp.ize.sharaku.common.acl” (API about the security for OS for thin clients, etc.), “jp.ize.sharaku.common.db” (API for accessing a database which a user makes), “jp.ize.sharaku.core” (API for using a custom component), “jp.ize.sharaku.io.filechooser” (API about a file operation,) and “jp.ize.sharaku.util” (API about application for OS for thin clients) can be included.

### (Example of a Development System of Operation)

FIG. 5 shows a screen shot related to the development tool.

For example, on the terminal 20-1, when software developer A actually starts, a window that is a main screen of this development tool is displayed on a desktop screen.

In this main screen, a window serving as tools is intelligibly arranged for software developer A who is get accustomed to a development tool, such as Visual Studio. As a window being the tools, a menu bar 201 which calls a function of development tools, such as a file operation, a tool bar 202 which iconifies a function of this menu bar and enables to access quickly, a component list 203 which is a component used for operating a program by pasting on a window on the design & code creation window 205, a panel management window 204 which displays a panel for every window and a component of an object related to a panel, a design & code creation window 205 (source file editor) which is for designing each window as a program to develop and for making a source code, and a property window 206 which sets up a property (a special feature, characteristics) and a screen design of a program are displayed.

Here, Software developer A makes the focus (make a window into an operational active state) of these windows with the pointing device 45, and program(s) can be developed in adjusting various values by a button on a screen, or inputting a code by the keyboard 40.

### (Step S101)

In the following, as reference to a flow chart of FIG. 10, typical operation of each window in case of actually developing a program is explained in more detail.

Firstly, software developer A uses the pointing device 45 and the keyboard 40, and chooses “Create New” in a file menu.

Accordingly, a project that is a framework of a program is created at a home directory of a user (in this case, software developer A) in the user storage part 103 of the server 10.

As these project files, it can be saved as an XML form file in which the file extension is, for example, “.prx”.

As this .prx file, a source code, etc., can be memorized by using, for example, a description method which is compatible for a XML form of AWML (AsWing Markup Language, provided at “http://www.aswing.org/”) and is a GUI-components library.

In addition, a design of a window made by using the property window 206 or a screen design tool which is not—illustrated and exclusive use tool, information on an icon, the contents of the class described the operation, etc., are able to memorize in it.

As the source file made at the time of creation of a project, the controller 101 of the server 10 transmits three files, (1) An AWML common file (common file), (2) Project.hx (windowing maker), (3) ProjectListener.hx (listeners class), which are memorized The library source database 106 as a fixed source file (general-purpose source file), and file(s) relevant to these files, from the network connection part 107.

The network connection part 27 of the terminal 20-1 receives these files via the network part 5, and the controller 21 memorizes them to the main memory part 22.

Subsequently, when a user operates the pointing device 45 and the keyboard 40, the controller 21 displays them on a window of a development tool currently displayed on the display 50.

As refer to FIG. 6, which is a screen shot of design & code creation window 205 corresponding to the display, the respective tab 2051 corresponds to (1), the tab 2052 corresponds to (2), and the tab 2053 corresponds to (3), which each is a screen shot of a tab (unit of a display) which displays a source code of each file.

These source codes can edit only a source code of (3) on the terminal 20-1 at a editing step of a source code of Step S104 as mentioned later.

A part of “Project” of Project.hx of (2) corresponds to an “application name” changed for application.

A name of application of a default (initial setting, default) at the time when a project is made is “Project.”

An application name can be designated by “Application Name” of the tab 2071 designated as compilation time (for example, (2) is set to Test.hx when an application name is set to “Test”).

As for a common file of AWML of (1), it is also enabled to make it include in (2) Project.hx.

As for a source file of (1), a type of a class, a window, a property of a panel described later, etc., are described by XML form as an AWML common file.

The controller 101 generates this code automatically based on the library source database 106 as mentioned above, and software developer A who is a user cannot edit it.

However, when a user edits a value of the property window 206, the controller 21 makes it automatically reflected as change of the source file.

A source file of (2) is described a source code of a main part of a program for an embodiment of the present invention. The controller 101 generates this code automatically based on the library source database 106 in the similar manner of (1), and software developer A who is the user cannot edit it.

Also, AWML corresponding to a screen design is embedded (2), change is reflected automatically every time when the screen design is fixed.

Further, it is provided: a main( ) function which is for a process of application starting, new( ) which is for a process of initialization, initComponents( ) function, a getListenerClassName( ) function which returns a name of a listeners class describing operation of each component, and a getRootJFrame( ) function which is for obtaining a JFrame component being a main windows of the application.

After a compile process is actually carried out, this code of (2) is shown as one window which can be executed as an executable file of Flash on a web browser.

In default, the number of window at run time is one; however, the user can add it freely.

The source codes of the default project can make an executable file (.swf file) displayed as one window, when a compile process is carried out as it is, as it is described later. A component added by change of a screen design is registered in order that a listener class of (3) can also be used simultaneously.

(3) is a listener class, and it is a class for describing operation of each component added to (2) and for describing operation of the program itself as a dedicated program.

For example, a source code, such as in the case of “What kind of process being made if a button is clicked?” is described in this file.

As this source code, in the configuration of a component step S102 described later, by arranging a component on the design & code creation window 205, the controller 101 adds a default source code, the user can edit this source code memorized in the temporary file storage part 104.

Because source codes are divided into (1), (2), and (3) as mentioned above, when the library source database 106 in the server 10 is updated, for example, only by replacing a source file related to (1) and (2), immediately, it enables to make an executable file which is applied to the newest development environment.

Also, for example, in case of making “embedded” applications such as for cellular phones or for PDA, and incase of making a software of a cross platform, etc., it enables to be devised only by replacing source files corresponding to (1) and (2).

For example, it is also enabled to make a “gadget” file of Windows (registered trademark) Vista, etc., which is different from AWML.

Also, the file of the user related to (3) is useful for many occasions by using as a library for the user himself, and the efficiency can be raised.

### (Step S102)

Then, configuration of each component of Step S102 is explained.

When software developer A uses pointing device 45, etc., and arranges a component of the component list 203 is on the tab 2050 of the design & code creation window 205, a desktop screen is updated as mentioned above; and, simultaneously, the source file preparing part 109 creates a corresponding source code to the Listener(application name).hx of (3).

For a development tool related to an embodiment of this invention, as shown in Table 1, a various kinds of components, such as a button and a text area, are available to use.

As this component, in order to make it usable with a development tool related to an embodiment of this invention, a source code of a class called IzeComponent is prepared for the library source database 106.

This IzeComponent can be made by using an above-mentioned AsWing component.

In this case, in all the classes of IzeComponent, a class inherited org.aswing.Component which is an AsWing component is used.

Also, all available components with using this development tool is made to inherit IzeComponent.

In addition, IzeComponent prepares a function (method) group for making an output to AWML and for dynamic editing of a property.

TABLE 1
Available component:

Button
Label
Text box
Text area
Progress bar
Toggle button
Check box
Radio button
Tool bar box
Scroll pane
Scroll bar
Slider
Panel
List
Combo box
Accordion
Tab
Load pane
Table
Adjuster
Tree
Notation (memo)

Further, as this component, except for a standard component which a development tool related to an embodiment of the invention prepares commonly, a user is able to make a component independently.

This component made independently by a user is called as a custom component.

In order to make this custom component, “components” directory directly under the home directory of a user is made, and a file of “components.xml” is made in this directory.

It enables to use the custom component by a user editing this file.

This file can also be made by using software of a “memo pad,” etc., which makes a file and is standard application included in the OS for thin clients.

Also, by choosing “creation of a file” from a file menu of the menu bar 201 by a user, the user can make it on the main memory part 22 of the terminal 20-1, and it can be transmitted to the server 10.

In addition, all files that a development tool related to an embodiment of the invention does not make can be made in a similar way.

In this case, as contents (form of a custom component) of a user's components/components.xml directly under a home directory, for example, the following codes can be used.

```
<component-list image-dir=“apps/ukiyoex2”>
    <component
      name=“Clock”
      available=“true”
      image=“images/custom/custom1.jpg”
      tool-tip=“Clock”
      package=“aaa.bbbb”
      swf=“clock.swf”
      class-name=“IzeClock”
      parser-name=“ClockParser”
      ui-name=“ClockUI”
      awml-tag=“clock”
    />
</component-list>
```

A code which describes processing of this custom component can be made from four source codes, a component class, UI class, a parser class, and an IzeComponent inherited class that inherits above-mentioned IzeComponent.

Here, a component class is a class which can inherit org.aswing.Component and which describes an actual component. UI class is a class for using in the component class and determining external appearance.

A parser class is a class for outputting and inputting XML information as AWML.

Correlation with a property, an event, and a tag and attribution information can be performed.

An IzeComponent inherited class is a class for using and cooperating with a development tool related to an embodiment of this invention.

Information required for setting and obtaining of a property, and automatic generation of an event processing source code, etc., can be described.

Further details of this custom component are described later.

### (Step S103)

Then, in Step S103, when an above-mentioned component is added to the design & code creation window 205, a property for this component can be set up.

About operation by a user in this state for a window of a development tool related to an embodiment of this invention, it explains as refer to FIG. 7A and FIG. 7B.

Firstly, software developer A changes each value of the tab 2061 which sets up a property of the property window 206 with the keyboard 40 or the pointing device 45.

Accordingly, a property that each component displays on execution time can be set up.

Further, when each property is need to be set up in more detail, the setting window 2063 which is a setting window of external appearance accompanying with this is displayed.

Software developer A can be also changed about this value.

### (Step S104)

Then, in Step S104, software developer A sets up operation of each component in the tab 2062 of the property window 206. Hence, when a user edits “value” about an event shown by “key” and clicks the “edit” button, this information will be transmitted from the network connection part 27 by the controller 21 of the terminal 20-1.

The network connection part 107 of the server 10 receives with this, and the controller 101 of the server 10 detects it.

Here, the controller 101 read when a custom component is described by user.

As for a standard component, the controller 101 obtains an event corresponding to “key” of the library source database 106 from component information of a standard component that is described in above-mentioned “componentlist.xml” having read previously.

Then, the source file preparing part 109 reads a default general-purpose source code memorized in the library source database 106 and generates a source code automatically.

In this manner, the source file preparing part 109 generates a corresponding source code in the user storage part 103 of the server 10.

A reading process of this component is explained in more detail.

Firstly, suppose that the above-mentioned “edit” button is pushed by software developer.

When the controller 101 of the server 10 has detected with this via an above-mentioned process, the controller 101 reads a default source code of a standard component memorized in the library source database 106, and adds to an above-mentioned source file.

Here, when a user makes a components.xml file, it is carried out a process which reads a custom component (not included in a standard component) made by A user independently. This processing is explained.

Hence, when there is a components/components.xml directly under the user's home, the controller 101 checks a path (position of a file), confirms having existence/non-existence a file in which a source code is included, and confirms there is/is not an authority to read or use the file.

When the file does not exist or there is no authority to be used, warning is displayed, and the component is not read and is ignored.

When there is the file and also there is authority to be used, a component is added to a list, and it changes into an available state.

Further, in a development tool of an embodiment of this invention, a component can usually read a custom component by setting up.

In this case, if reading of a configuration file of this custom component is unsuccessful at a start-up of the development tool, a button is not primarily added to the component list 203, and a user can not use it.

Also, a user can use a “custom type,” which is a data type of a program.

In this case, it is necessary to make a types/types.xml file by a compile process directly under home directory of the user.

The controller 101 refers to this types/types.xml file before reading of components/components.xml.

When there is this types/types.xml file, the controller 101 checks a path (position of a file) and confirms there is/is not a file in which a source code is included and there is/is not an authority to read or use a file.

When this file does not exist or there is no authority to be used, warning is displayed and custom type is not read and is ignored.

When there is this file and also there is authority to be used, a custom type becomes to be a usable state.

In addition, “.swf file” used as a binary file for a custom type, which is a file comprised of a numerical value instead of a letter, such as an executable file, is also placed to this directory.

After the source file preparing part 109 makes a source code at an above-mentioned step, the network connection part 107 transmits this source code to the terminal 20-1 via the network part 5; the network connection part 27 of the terminal 20-1 receives; and it memorizes to the main memory part 22 of the terminal 20-1.

The controller 21 adds it and displays on the design & code creation window 205 shown in the display 50.

An example of setting of a source code, which sets up operation of an above-mentioned component, is explained.

For example, software developer A pastes a component of a button (Button1) on the tab 2050 of the design & code creation window 205, as a number (value) of “on-clicked” of the tab 2062 of a property is set to “on Button1Clicked,” and the “edit” button is clicked, the following source codes will be generated in a listeners class.

public function onButton1Clicked(source:Component,
clickCount:Float):Void
{
// (a process is described here.)
}

When there is no value, a function name relevant to an event name of each component name is used for a default value.

Software developer A is describing a process required in this source code by using keyboard 40, etc., a program which is dedicated software and customized according to needs of a company of companies, such as the customer B can be developed.

### (Step S105)

Then, software developer A compiles a source file, in order to make an executable file (for example, .swf file), after completing each source code.

In the case of this compile, operation which a user carries out is explained in more detail with reference to FIG. 8A and FIG. 8B.

Specifically, when software developer A chooses a command which carries out a compile process by selecting “compile” from a file menu of the menu bar 201, or by selecting “a triangular arrow to a circle” button in a right end of the tool bar 202, as used the pointing device 45 and keyboard 40, etc., a compile window 207 (debugger) shown in FIG. 8A is displayed.

In this compile window, software developer A can also carry out setting in case of the compile process of the application, reception of a message, debugging, etc., by each tab of the tab 2071, the tab 2072, and the tab 2073.

When software developer A selects the tab 2071, an above-mentioned application name can be changed. Also, an icon used for application can be selected; and when a user selects it, the controller 21 displays the icon on apart of “preview.”

When software developer A selects the tab 2072, screen resolution in case of executing .swf file which is an executable file made after a compile process can be set up.

FPS (frame par second, number of time of drawing for 1 second) which is the attribute of a .swf file can be set up.

In addition, a user can also select the tab 2071, and the controller 21 displays a message in a message box of this tab at the time of the compile process as described later.

As this message, a message, such as, whether a compile process is succeeded or failed, etc., is displayed.

Further, when a compile process is unsuccessful, an error message, etc., is displayed on the tab 2071, and it can be debugged, such as pointing to a source code of a part from which an error arose or displaying a message in the cases, such as stepwise execution, etc.

When carrying out setting of this stepwise execution and breakpoint, trace, and a watch, “stepwise execution,” etc., can be individually selected from a file menu by using the “->” (arrow) mark of the tool bar 202.

When software developer A selects the “compile” button of this compile window in the pointing device 45 or keyboard 40, etc., information is transmitted and received between the terminal 20-1 and the server 10, and a compile process is executed, and also a push on the “close” button will cancel a compile process.

A process of Step S105 which is this step is explained in more detail as refer to a flow chart of FIG. 11A, and a timing chart of FIG. 11B.

### (Step S1051)

Firstly, in Step S1051, the controller 21 of the terminal 20-1 transmits: a command which carries out an above-mentioned compile process from the network connection part 27 to the network part 5, and above-mentioned files of (1), (2), and (3), which is source file(s) containing source code(s) completed by the software developer A.

Here, when (1) is included in a file of (2), (2) and (3) are transmitted.

This corresponds to “Transmit a source file” in FIG. 11B.

### (Step S1052)

The network connection part 107 of the server 10 receives an above-mentioned command and the source file, and memorizes them to the temporary file storage part 104.

Further, it is notified to the controller 101 that a source file has been received.

At this time, a file which is a source in a home directory of software developer A in the user storage part 103 does not update.

Also, when the controller 101 estimates that reception was unsuccessful at this time, a fragment of a file memorized in the temporary file storage part 104 is deleted, and an error message as receiving failed is transmitted towards the client 20-1 from the network connection part 107.

### (Step S1053)

Then, the compile process part 102 of the server 10 executes a actual compile process based on a source file memorized in the temporary file storage part 104.

Here, in this source file, when a library and API which are commonly usable files to software development are used, or a source code is saved at the library source database 106, the controller 101 includes (include process) with these.

When including a binary file which is not provided with a source code, the controller 101 obtains a binary file from the library binary database 105 and includes or links.

Accordingly, when a compile process of a source code is successful, the controller 101 makes .swf file which is usually a single executable file to the temporary file storage part 104.

When a compile process is unsuccessful, the controller 101 memorizes an error message at the time of a compile process to the temporary file storage part 104.

### (Step S1054)

Then, in Step S1054, the controller 101 judges whether a compile process of Step S1053 was successful.

When a compile process is unsuccessful, the controller 101 advances a process to Step S1055.

When a compile process is successful, the controller 101 advances a process to Step S1056.

### (Step S1055)

In Step S1055, the user interface part 108 outputs an error message at the time of a compile process from the network connection part 107.

This step corresponds to “a response of success or failure” in FIG. 11B.

The network connection part 27 of the terminal 20-1 receives this error message via the network part 5, and the controller 21 outputs it to the tab 2073.

A development system of the present invention is achieved an Integrated Development Environment.

Therefore, when a user clicks this error message with the pointing device 45, it is enabled to move to a part of a source code with the error.

### (Step S1056)

In Step S1056, the controller 101 copies .swf file which is an executable file memorized in the temporary file storage part 104 to a home directory of the user storage part 103.

### (Step S1057)

Then, in Step S1057, as for the user interface part 108, a message of a compile process succeeded as like is received by the network connection part 27 of the terminal 20-1 via the network part 5, and the controller 21 outputs to the tab 2073.

This step also corresponds to “Response of success or failure” in FIG. 11B.

Also about this successful message, etc., the network connection part 27 of the terminal 20-1 receives via the network part 5, and the controller 21 outputs to the tab 2073.

### (Step S1058)

Then, in Step S1058, the controller 101 updates desktop.xml.

Specifically, data that an icon for calling compiled .swf file to be displayed is added to desktop.xml.

Also, this updated desktop.xml is transmitted from the server 10 as mentioned above and is displayed on the display 50 of the client 20-1.

Accordingly, after software developer A who is a user closes a window of a development tool, by clicking on this icon, this .swf file can be executed immediately.

Therefore, an effect is acquired that preparation for performing a test, etc., is ensured for made software.

When having set up to output this .swf to a shared folder as described later, the customer B executes and checks (tries) immediately is enabled.

A compile process is ended when renewal of this desktop.xml is able to be performed.

Software developer A who is a user can be debugged by using a tool menu of the menu bar 201, the “->” (arrow) mark of the tool bar 202, etc.

When a user debugs, an executable file is transmitted to the terminal 20-1 from the server 10, an icon is displayed as a preview, and the controller 21 executes.

A user is to be carried out tracing which executes a program to a position of a source code based on the executable file and source file, setting up breakpoint, carrying out stepwise execution in every line, or referring a value of a variable by a watch window which is not illustrated.

It is also enabled to stop a program at a time of being a variable shown some value or occurring an exception. Remote debugging carried out by a program for terminals of a dedicated software development tool read into the terminal 20-1 and the server 10 cooperating as these processes can be carried out.

Software developer A further makes edit the source code and repeats debugging and a compile process, a dedicated software can be completed.

Software developer A can replace a process up to Step S101-Step S105 suitably and can perform it.

Hence, although an embodiment of this invention does not have simple wizard form and fixed user interface such as the conventional technology 1, it is enabled to achieve an advanced Integrated Development Environment on a web.

### (Example of a Procedure of Development)

Subsequently, a process until actually making and executing a code is explained as refer to FIG. 5 and FIG. 7C, which are the windows of a development tool related to an embodiment of this invention, and FIG. 9, which is a screen shot in case of a user actually executing the dedicated software.

Firstly, software developer A who is a user made a project as the above procedures and set an application name to “SamplePanel.”

Here, a development tool related to an embodiment of this invention makes an executable file (.swf file) which usually serves as a single window by a single file because of using As Wing.

However, in case of making an application, when confirming registered information, two screens, that is, a “registration picture” for inputting information and a “confirmation screen” for confirming an error of inputted information may be made.

In this case, it exists some demand of a user that the window itself should be only one.

In order to satisfy such demands, it is provided that the panel management window 204 is prepared and a framework switched a panel (display element) in the same window.

For example, in addition to a standard window, the user can make the second panel or more when the user carries out “creation of a panel” of the menu bar 201.

Here, an example of the panel management window 204 when a user makes two windows is explained.

Firstly, at the time a project is created, only the window 1 called “Panel1” is displayed on the panel management window 204.

Here, “creation of a panel” will display “Panel2” on the tab 2064 as mentioned above.

In addition, “Panel1” and “Panel2” are panel names and a user can change them freely.

Secondly, software developer A sets up a property to have the following constructions as a simplified example of explanation about AWML of a screen design, in order to use “Panel1” as a “registration screen” and “Panel2” as a “confirmation screen.”

<frame>
<panel name=“Panel1” visible=“true” />
<panel name=“Panel2” visible=“false” />
</frame>

Further, in the tab 2065, a function in an object (or class) of each panel can be displayed.

Specifically, for example, when a user double-clicks a triangle mark which exists beside “Panel1” with the pointing device 45, the controller 21 displays a table of a function.

When the user double-clicks a function shown in a table of the function, the controller 21 moves and displays cursor (means which shows a position to input) on a place of a corresponding function in the design & code creation window 205.

Also, in a development tool related to the embodiment of this invention, function (method) showPane( ) for switching a display of a panel to an AbstractAppListener class is provided in “jp.ize.sharaku.core” which is API.

Consequently, it can be switched the display by passing panel names, such as “Panel1”, as like to showPane (“Panel1”).

Here, when switching a display at the time of a button click, software developer A can be inputted for the following codes.

public function gotoPanel2(source:Component,
clickCount:Float):Void
{
getComponent(“Label4”).setText(getComponent(“TextField1”).get
Text( )); //An entry content of a name is set to a check.
var seibetsu:String = “”;
if (getComponent(“RadioButton1”).isSelected( )) {
//When a “man” is selected, it is displayed as a “man.”
seibetsu = getComponent(“RadioButton1”).getText( );
} else if (getComponent(“RadioButton2”).isSelected( )) {
//When a “woman” is selected, it is displayed as a “woman.”
seibetsu = getComponent(“RadioButton2”).getText( );
} else {
// If nothing is selected, a “man” is used as an initial value.
seibetsu = getComponent(“RadioButton1”).getText( );
}
getComponent(“Label6”).setText (seibetsu); // The contents
of selection of sex are set to a check.
showPane(“Panel2”); // Panel2 It is a change about a display.
}

This code is as a property of a “check” button,

<button x=“100” y=“120” width=“140” height=“20” enabled=“true” visible=“true” opaque=“true” hand-id=“Button1” on-clicked=“SamplePanel.gotoPanel2” horizontal-align=“center” vertical-align=“center” horizontal-position=“right” vertical-position=“center” icon-text-gap=“2” text=“confirm”><background alpha=“100” rgb=“C0C0C0”></background><foreground alpha=“100” rgb=“000000”></foreground><font embeded=“false” underline=“false” italic=“false” bold=“false” size=“11” name=“Tahoma”></font><margins bottom=“0” right=“0” left=“0” top=“0”></margins></button>

such as

on-clicked=“SamplePanel.gotoPanel2”

is defined.

Hence, when a user clicks with this, it is shown that gotoPanel2( ) is called.

The definition can be set up as this at the setting time of a property by inputting value “gotoPanel2” into “on-clicked” of the “Events” tab (tab 2062) in the property window 206.

Also, each window made in a project can change a displaying condition by changing a property.

Thereby, to make a window translucent or to change default size is enabled.

### (Execution of a Binary File)

An application name “SamplePanel” which is an example of above-mentioned application developed with a development system related to an embodiment of this invention is explained in detail as refer to FIG. 9.

Firstly, software developer A who is a user carries out a compile process, the “SamplePanel” icon on a screen shall be displayed.

Here, a user inputs an execute command by double-clicking this icon by using pointing device 45, etc., or pressing the enter key of the keyboard 40, etc.

The controller 21 outputs this execute command from the network connection part 27.

The network connection part 107 of the server 10 inputs the execute command via the network part 5.

When the user interface part 108 detects with this, the controller 101 outputs .swf file which is an executable file corresponding to “SamplePanel” memorized in user storage part from the network connection part 107.

Then, the network connection part 27 of the terminal 20-1 receives above-mentioned .swf file, and memorizes in the main memory part 22.

Further, the controller 21 executes .swf file and displays on the display 50.

When the screen shot 3001 which is an example of a screen shot in this case is referred to, the controller 21 displays a window corresponding to “Panel1” on a desktop screen.

When a user checks “test Taro” to a name field and sex to “man” and clicks a “check” button by pointing device 45, etc., the controller 21 displays a window corresponding to “Panel2” on a desktop screen such as the screen shot 3002.

Thus, a development system related to an embodiment of the invention has the feature that a screen change in a plurality of windows is realizable.

### (Example in a Case of Developing Jointly)

When developing dedicated software, a plurality of software developers may usually develop jointly.

In this case, when a certain user (for example, software developer A) takes the lead and develops software, in a development system related to an embodiment of this invention, it is enabled to cope with it with devising configuration of a file for custom components.

Firstly, all the files are placed to “components/” which is directly under a home directory of software developer A. Secondly, all the files are similarly arranged to “types/” directly under home directory of software developer A.

Further, for example, software developer C, who is an associate developer, uses OS for thin clients on the terminal 20-3, accesses the server 10, and starts a development system.

Software developer C reads a project in a directory of software developer B by the development system.

Accordingly, software developer A and software developer C can carry out software development jointly about the same project.

In addition, of course, it is enabled to set up that a directory memorizing this project cannot be accessed unless a group of a developer of the same project.

Also, when carrying out software development jointly as mentioned above, the version control part 111 memorizes to the user storage part 103, for example, in CVS form at every compile process about a changed part in case of a user fixing the source code.

Hence, information about renewal of the source file and the executable file is memorized and managed.

Accordingly, being unconscious of management of the source code, developing dedicated software together is enabling.

Also, for example, the terminal 20-1 or 20-2, etc., transmits a source code which a user changed for every fixed time to the server 10; and the controller 101 of the server 10 is able to memorize it to a temporary file storage part.

Accordingly, in case that the terminal 20-1 or 20-2 is shut down by a power failure, etc., or is out of order, etc., at the time of usage of a development system, since a source code is memorized on a server, development can be continued by accessing the server 10 once again.

Further, when an above-mentioned source code is compiled, software developer C can also access a desktop of software developer A, whose desktop.xml is updated.

For this reason, it is enabled to check made .swf file immediately in the similar manner as software developer A.

In a development system related to an embodiment of the invention, the treating part between users 110 of the server 10 is provided.

When the treating part between users 110 can have an operation such as so-called “messenger” software, which exchanges a message and communicates among users, and there is a function, which notifies other, user accessed when the user accesses the server 10.

Further, it is enabled to take contact between users by an E-mail, BBS (bulletin board system), chats, voice chats, etc., among other terminals of a user.

Furthermore, by technology, such as RSS, it is enabled to notify to a terminal that information of BBS, etc., is updated.

Accordingly, dedicated software can be more efficiently developed by the software developers who are present in remote locations.

### (Increase in Efficiency of Development of Dedicated Software)

Then, a process of above-mentioned development progresses to some extent, and a case where a request for revision of software is carried out to the customer B is explained with reference to FIG. 12 which is a timing chart.

In the case, software developer A develops dedicated software according to an above-mentioned process and makes advancing development to a stage in which a compile process is enabled.

Further, software developer A selects “setting of a project” from the menu bar 201 and changes an output folder of an executable file of a project.

Specifically, a “shared folder” which is an directory accessible for the customer B is designated.

Further, software developer A carries out the above compile processes.

Here, the customer B starts OS for thin clients with the terminal 20-2.

Software developer A can check that the customer B has accessed the server 10 by the above-mentioned treating part between users 110.

After checking is ensured, software developer A can transmit a message about “the compile process is completed” to the customer B by the treating part between users 110.

The user of customer B can open a “shared folder” when the message is received at the terminal 20-2.

Then, desktop.xml of home directory of the customer B is updated by above-mentioned process, and a memory content of a shared folder is displayed.

In this display, .swf file that the compile process part 102 of the server 10 made is displayed as an icon in the similar manner of the desktop screen of software developer A. By executing .swf file in this shared folder, the customer B can check dedicated software.

Here, in case that the customer B issues instructions of modification, the treating part between users 110 can be used and a request for revision can be carried out to software developer A.

Software developer A that received a request for revision modifies a source code, and carries out a compile process as mentioned above.

After that, the customer B can execute .swf file in the shared folder again, and can check dedicated software.

Here, if there is a further request for revision, it can carry out by using the treating part between users 110, again. If the revision can be satisfied, that is told by using the treating part between users 110.

Accordingly, software developer A finishes development of dedicated software.

Development costs can be settled with the customers B by a payment means in the server 10 which is not illustrated.

Thus, since modification instructions of software and execution check can be done in the state close to “real time,” an effect that software can be developed extremely efficiently is acquired.

Accordingly, it enables to reduce human-induced cost significantly, such as visiting a company directly for instruction of an order and a correction received by the company, or showing a proposal.

Also, the customer B is to be always executed a dedicated software by only copying .swf file of the dedicated software to his desktop screen from a shared folder.

Hence, an effect that operation of difficult installation, etc., for customer B is unnecessary at all is acquired. This enables to reduce costs, such as traveling expenses for software developer A to install software on the of customer B's PC.

Further, since the server 10 is a server with which backup, etc., are carried out suitably, as compared with a case that a user installs dedicated software in his PC, an effect is acquired that tolerance to a failure such as an out of order of HDD is high.

Furthermore, since all the files are saved on a server and compile is carried out on the server, it is enabled to carry out a compile process for always the same development environment by updating a file on a server; therefore, it becomes enabled to reduce a bug (mistake on software) and fault occurred by the difference in environment between software developers as much as possible.

Accordingly, it senables to reduce human-induced cost further.

Also, in a development system related to an embodiment of this invention, the pliability of a program to develop is higher than that of a fixed user interface of wizard form as fixed by the conventional technology 1.

Thus, it enables to make dedicated software united more with needs of a company.

An effect is obtained that a leak of a source code can be prevented by developing on a desktop screen by using OS for thin clients.

Accordingly, in development of a software to be highly secret, an effect is acquired for enabling to reduce a leak of information as much as possible.

About an executable file, it also memorizes in the server 10 only; in OS for thin clients, since there is no means to carry out this executable file outside; and it enables to reduce as much as possible also about a leak of information by disassembling, etc.

In addition, in a development system related to an above-mentioned embodiment of this invention, although it explains that a case that OS for thin clients for exclusive use is used, it is enabled to develop by using a terminal which naturally uses other general-purpose OS.

As this versatile OS, for example, it may connect with the server 10 by using the OSs, such as Windows (registered trademark) XP, Mac OS (registered trademark) X, and UNIX (registered trademark) or Linux (registered trademark).

When the general-purpose OS is used for a terminal, after OS of a terminal starts, software developer A or the customer B who is a user accesses the server 10 by using web browsers, such as Internet Explorer (registered trademark,) or FireFox (registered trademark).

Then, after carrying out user authentication, a desktop screen memorized in the server 10 is displayed as Flash of one sheet.

By this, it enables to use the development system in the similar manner in a case that above-mentioned OS for thin clients is used.

This configuration has an advantage with ease because it does not use a dedicated OS.

Hence, it enables a customer without a memory medium of OS for thin clients to check dedicated software, which is under a development, or finish a development easily.

Also, when dedicated software is developed together as above-mentioned, although it explained that a different user accesses and develops in a home directory of a different user, as a matter of course, it is also enabled to prepare a common directory and to memorize source file(s) there.

Further, in case of developing dedicated software in partnership by developers, as a matter of course, it is also enabled to develop by using a common directory for every group ID of a developer.

Also, in an above-mentioned embodiment, although it explained that a source file is transmitted to a server at a compilation time, and a modification of the source code is managed only within a terminal at the time of development, by transmitting a source file reflecting a source code, which a user edited, from the terminal side for every certain time, it is also enabled to accumulate a source file in the server side automatically.

Further, about a source file and a source code, when a source code is added to a source file accumulated in a server, the changed part is transmitted to a terminal, and modification is made, it is also enabled to have a configuration that adds the source code of the changed part to the source file of a server.

By this, even when a terminal is shut down by a sudden power failure, etc., since a source file is not lost unlike the conventional development system, development efficiency can be raised.

Further, a dedicated software which can be developed in a development system related to an embodiment of this invention is not only application for a thin client but also it can be targeted at all terminals with an execution environment of Flash (and executable file which is provided with a compatible script or an equivalent function of Flash) as the present versatile OS and a home electric appliances, etc., in the future.

Hence, it is enabled to develop dedicated software scalable from large-scale general-purpose application to embedded-oriented software.

A configuration and operation of the above-mentioned embodiment are an example, and it is needless to say that it can change suitably and can execute in the range which does not deviate from an aim of the present invention.

### INDUSTRIAL APPLICABILITY

The present invention can provide a development system of an Integrated Development Environment which can be used by a server terminal system.

Accordingly, a period of software development is shortened and it becomes enabled to reduce human-induced cost.

### BRIEF DESCRIPTION OF THE DRAWINGS

FIG. 1 is a conceptual diagram of a thin client server system related to an embodiment of this invention.

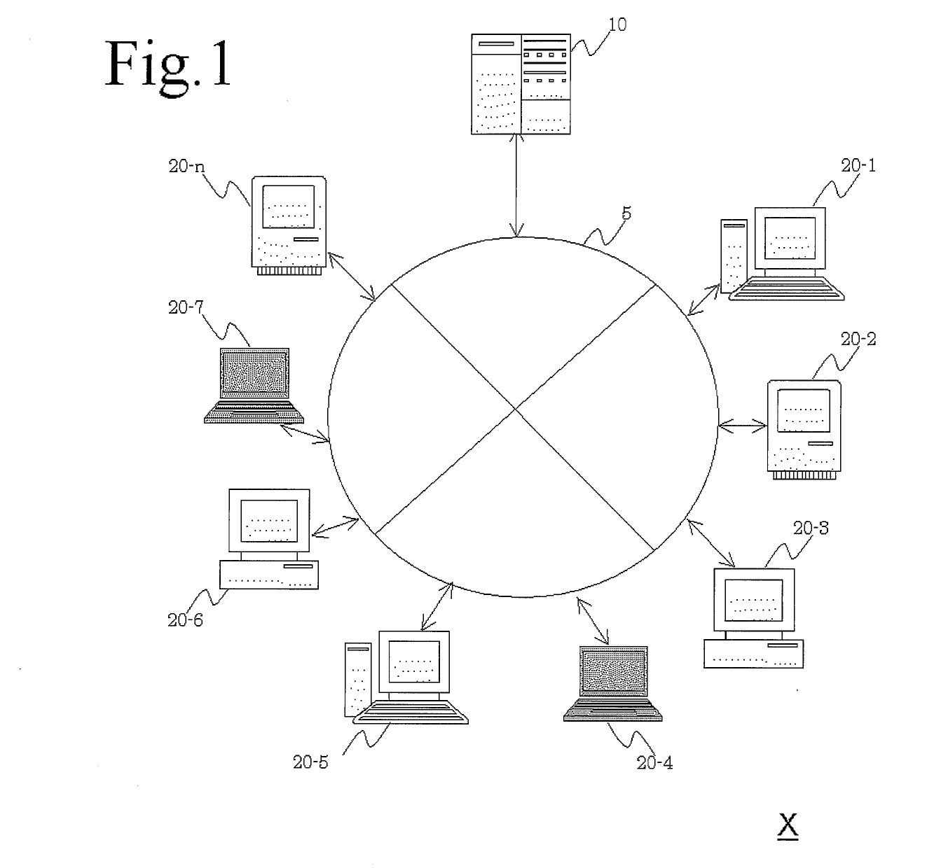

FIG. 2 is a block diagram showing a configuration of a server 10 related to an embodiment of this invention.

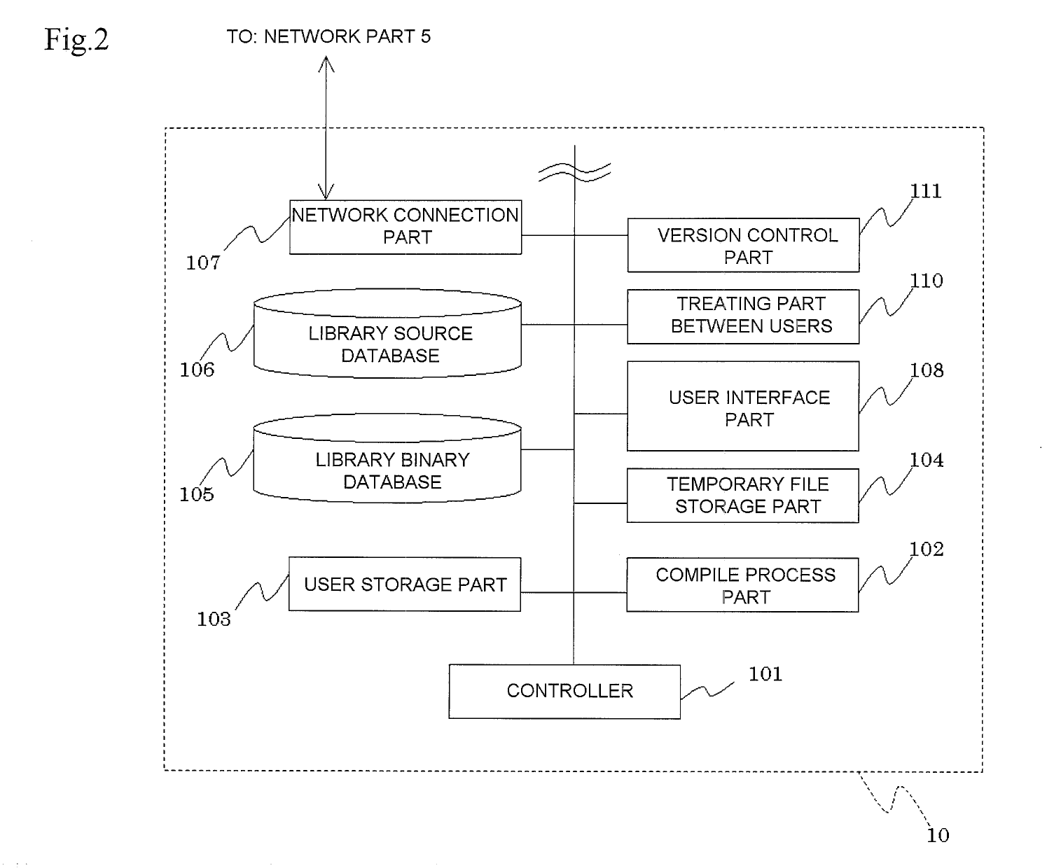

FIG. 3 is a block diagram showing a configuration of a terminal 20-1 related to an embodiment of this invention.

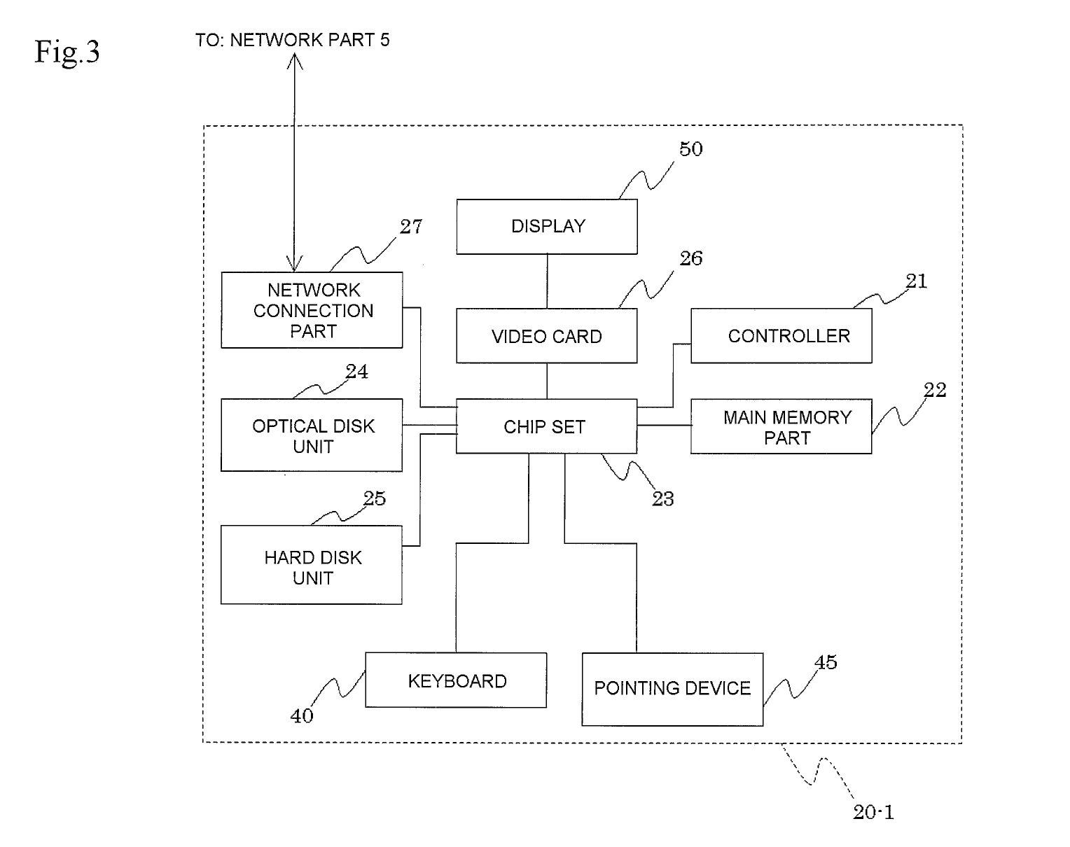

FIG. 4 is the screen shot which OS for thin clients starts related to an embodiment of this invention.

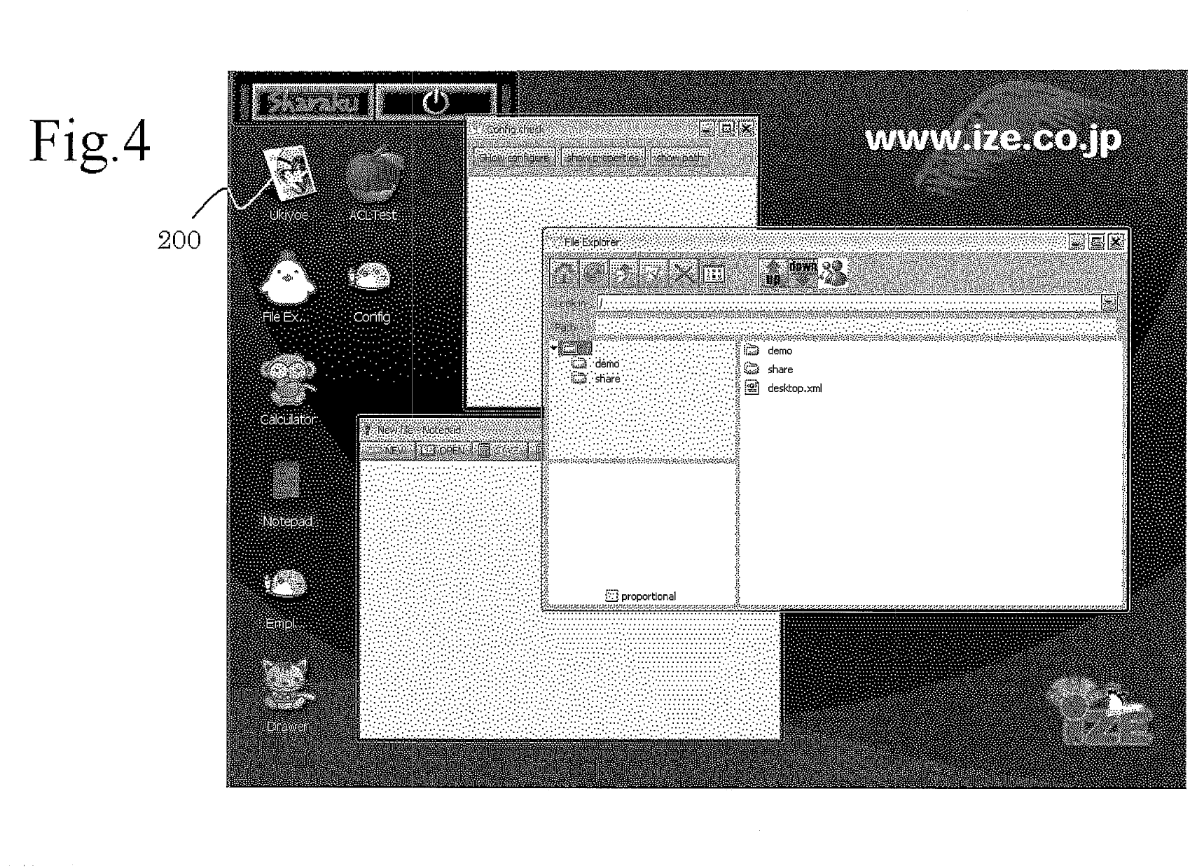

FIG. 5 is a screen shot of a development tool related to an embodiment of this invention.

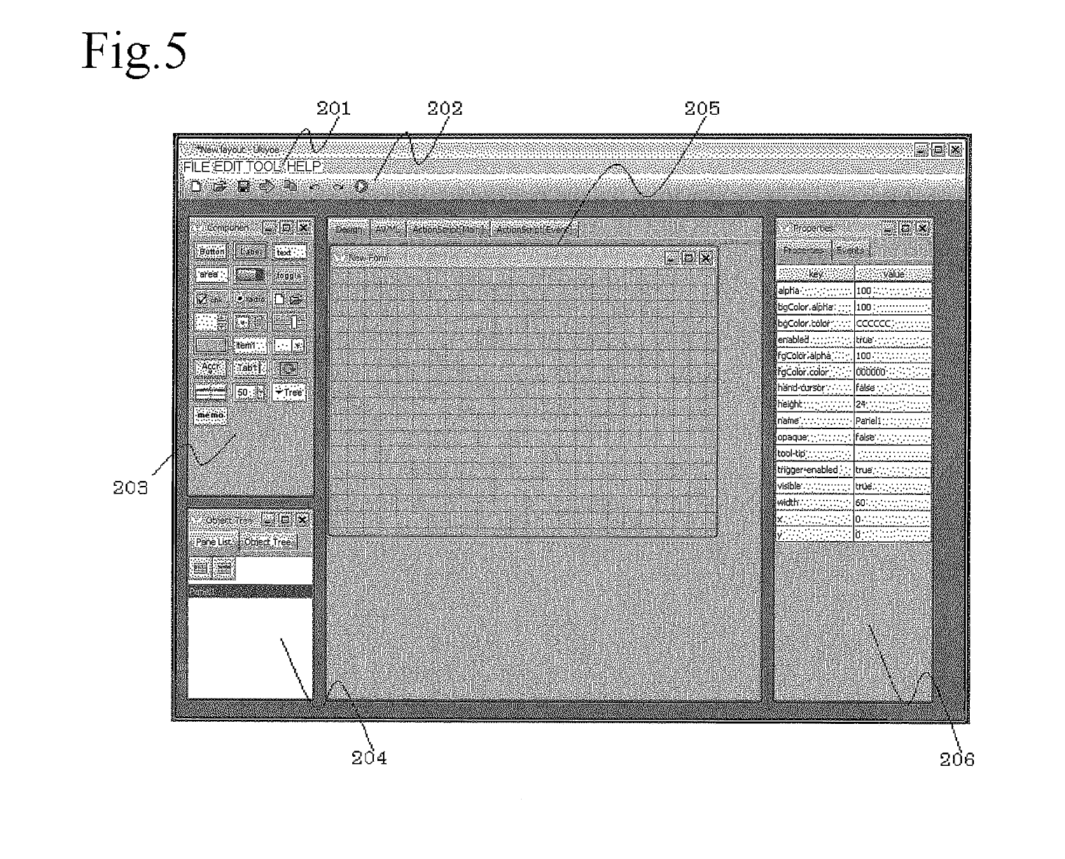

FIG. 6 is a screen shot of each tab of the design & code creation window 205 related to an embodiment of this invention.

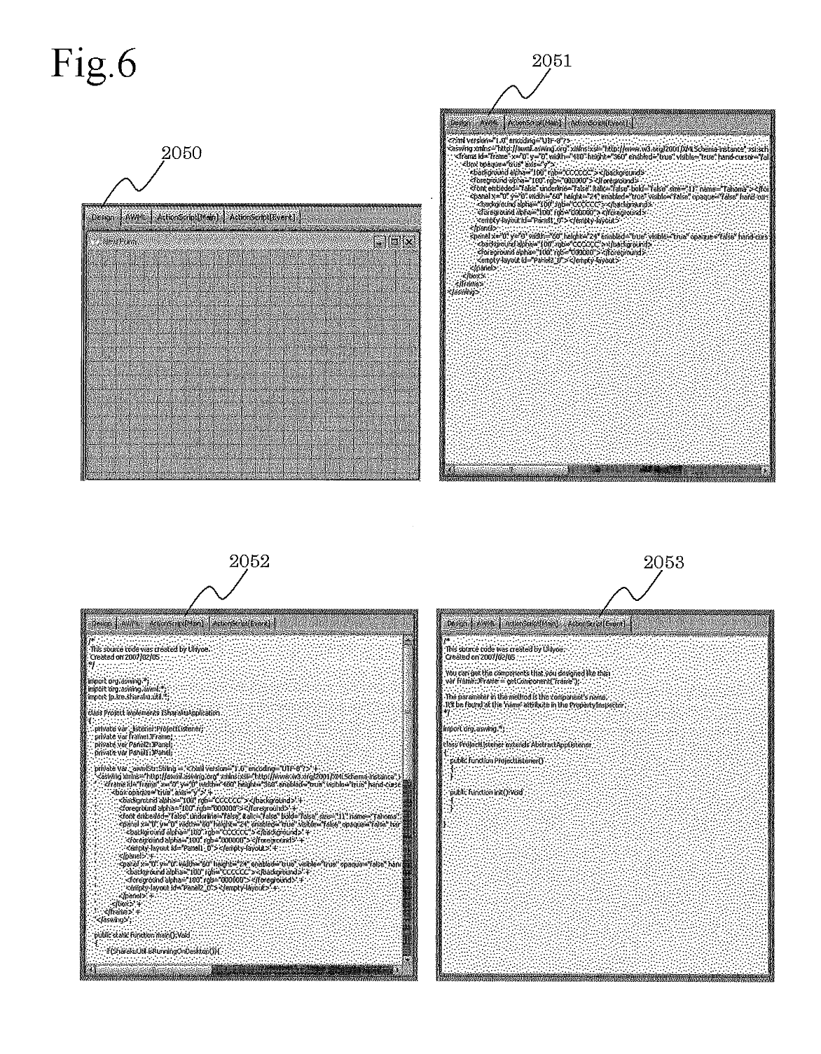

FIG. 7A is a screen shot about setting of the property of the development system related to an embodiment of this invention.

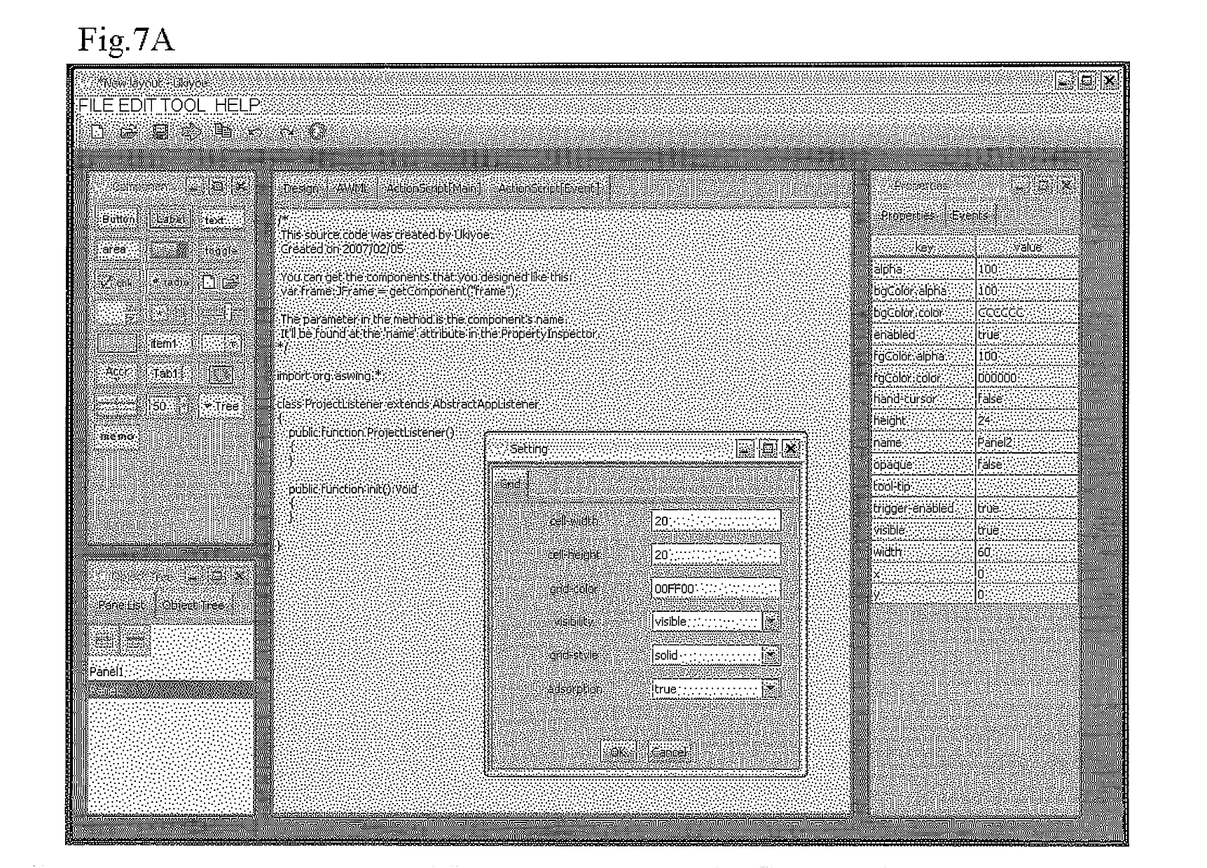

FIG. 7B is a screen shot showing each tab of a property window 206 and setting window of the development system related to an embodiment of this invention.

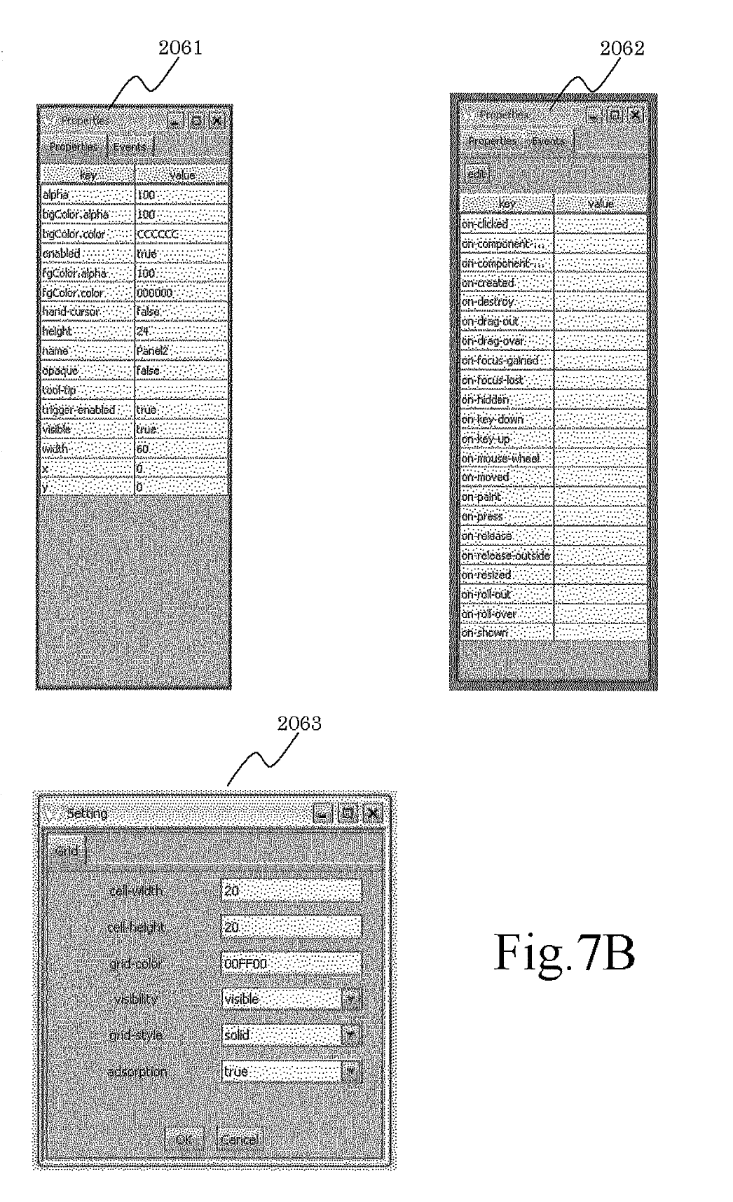

FIG. 7C is a screen shot of each tab of a panel management window 204 of the development system related to an embodiment of this invention.

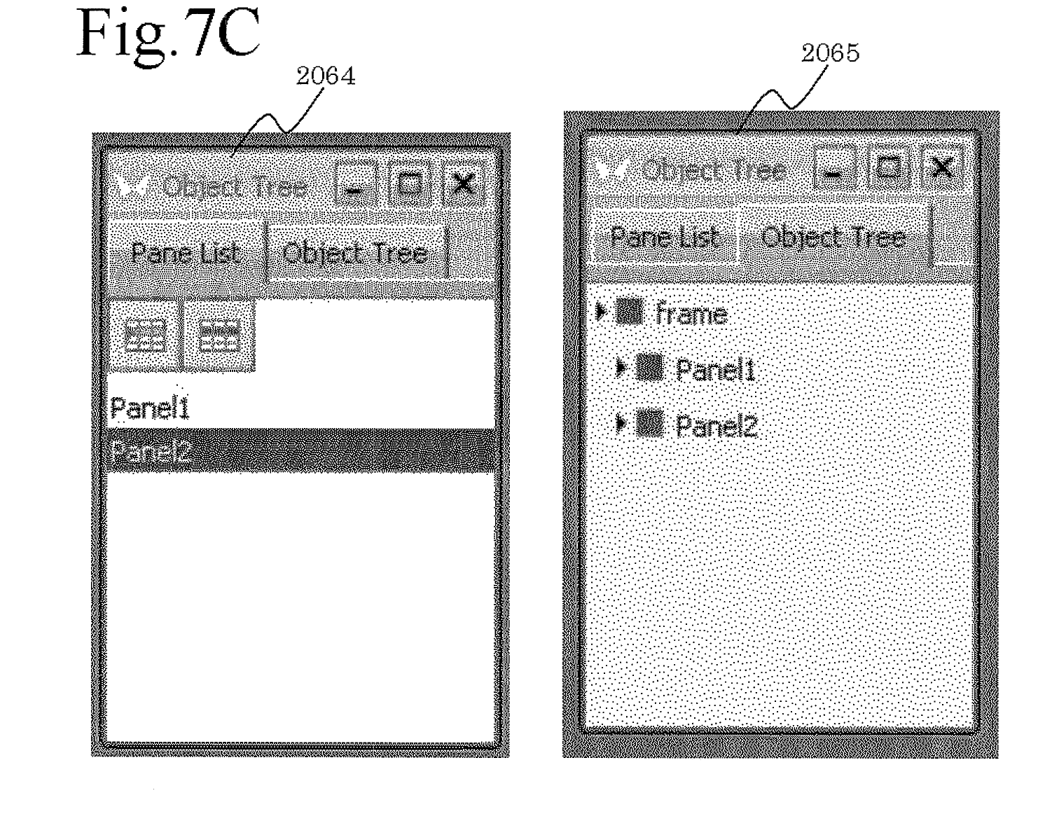

FIG. 8A is a screen shot about a compile window 207 of the development system related to an embodiment of this invention.

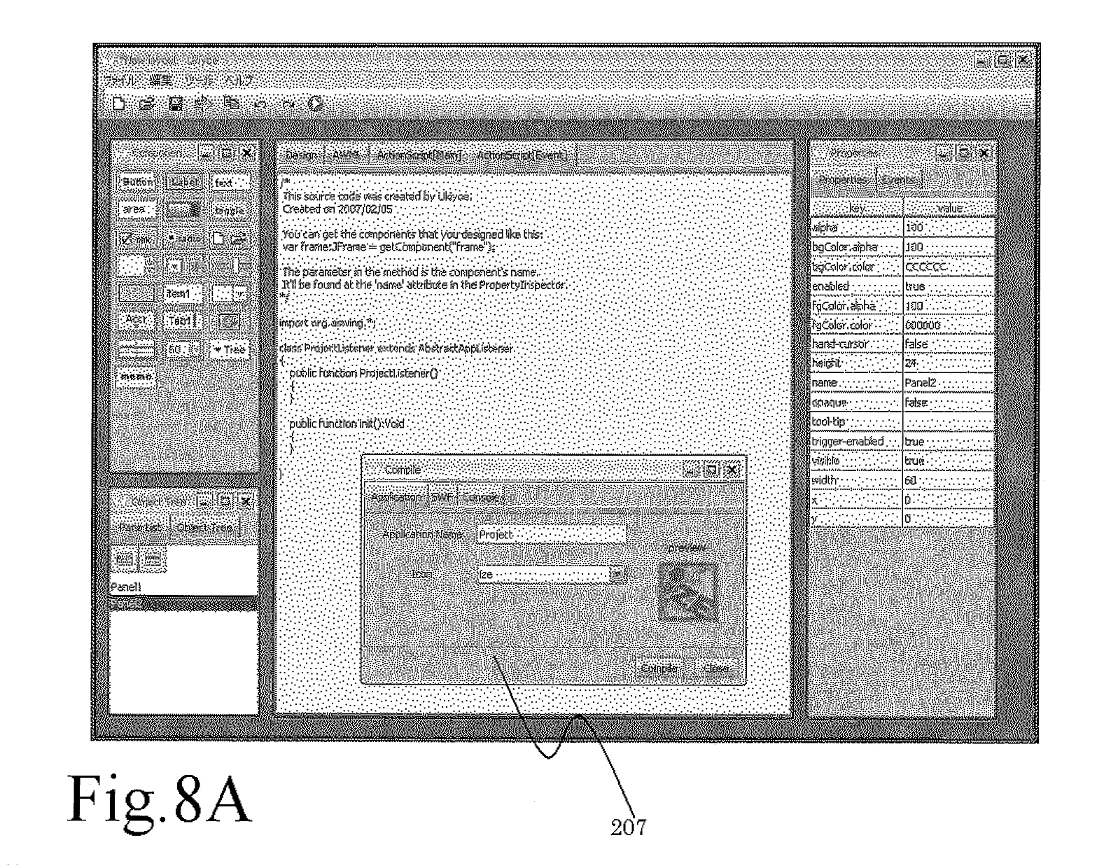

FIG. 8B is a screen shot of each tab of a compile window 207 of the development system related to an embodiment of this invention.

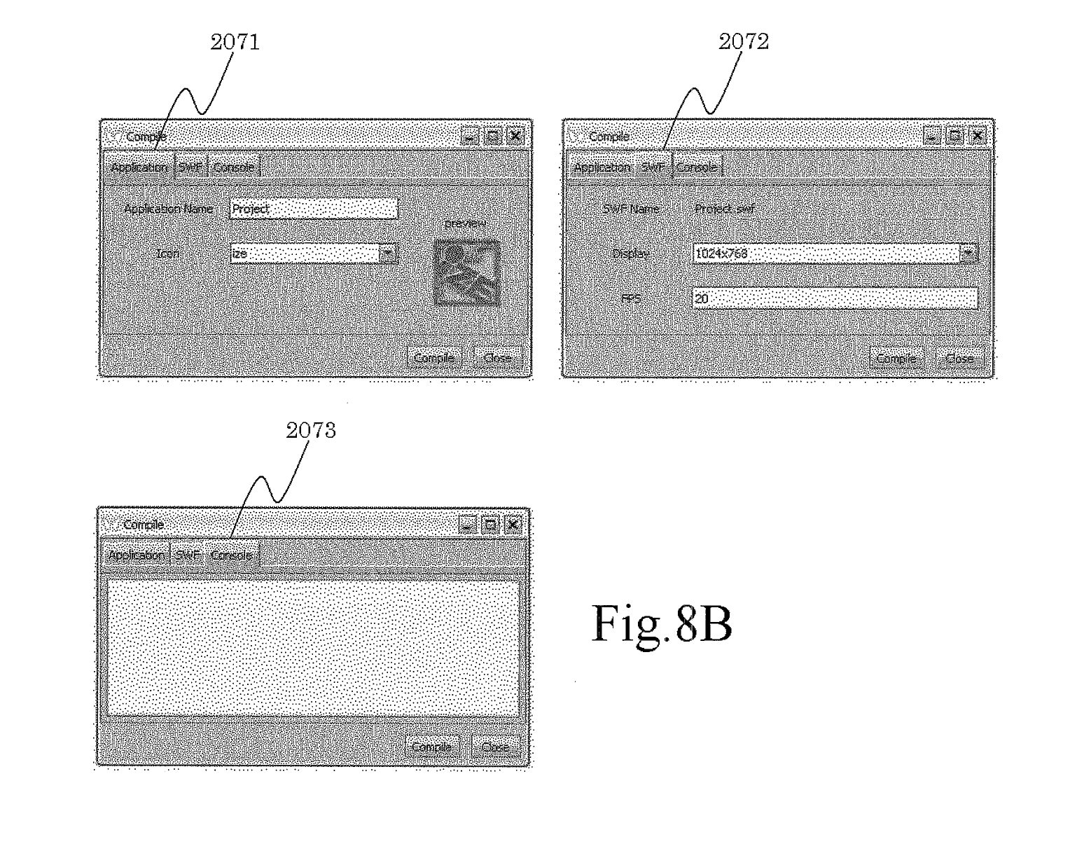

FIG. 9 is a screen shot of an application developed with the development system related to an embodiment of this invention.

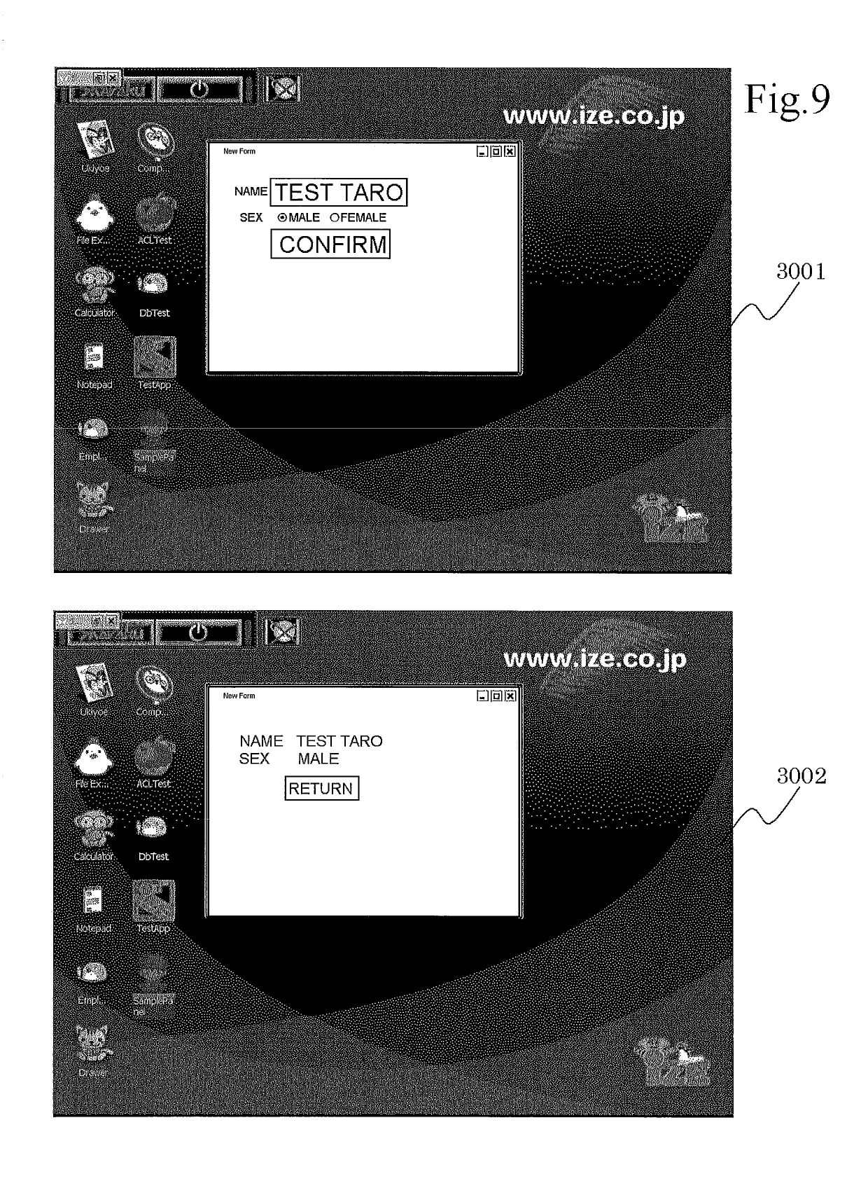

FIG. 10 is a flow chart showing a process of development of the development system related to an embodiment of this invention.

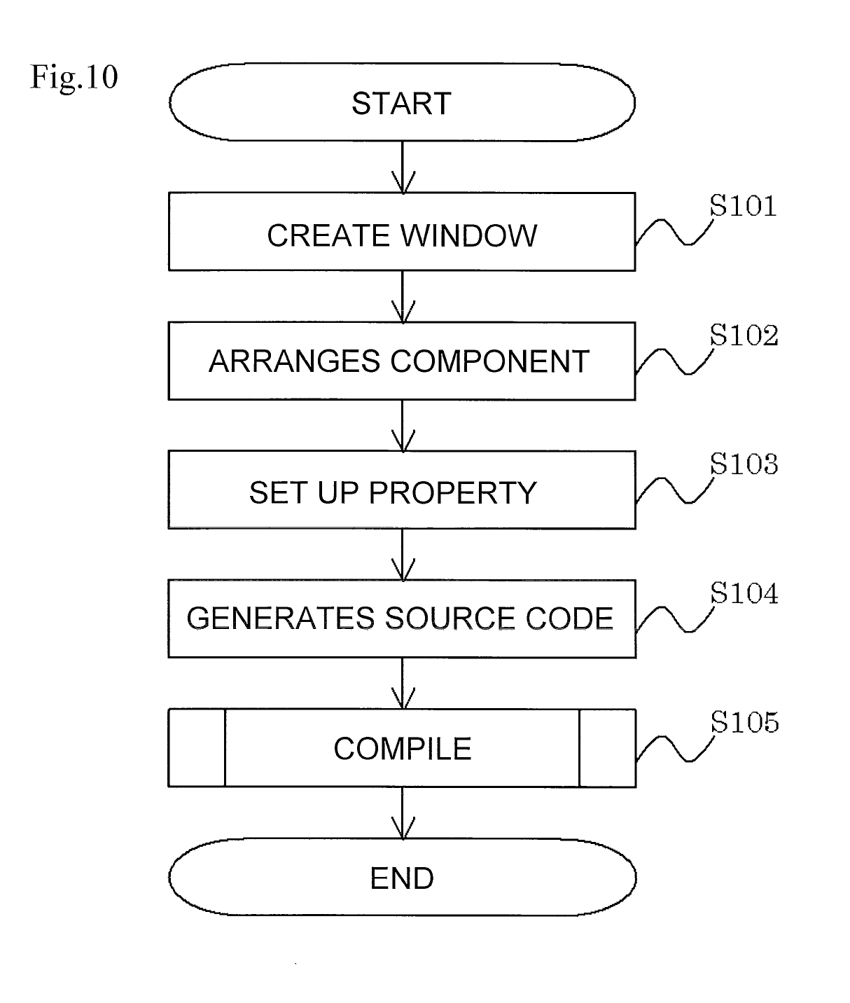

FIG. 11A is a flow chart which shows the compile process of development of the development system related to an embodiment of this invention.

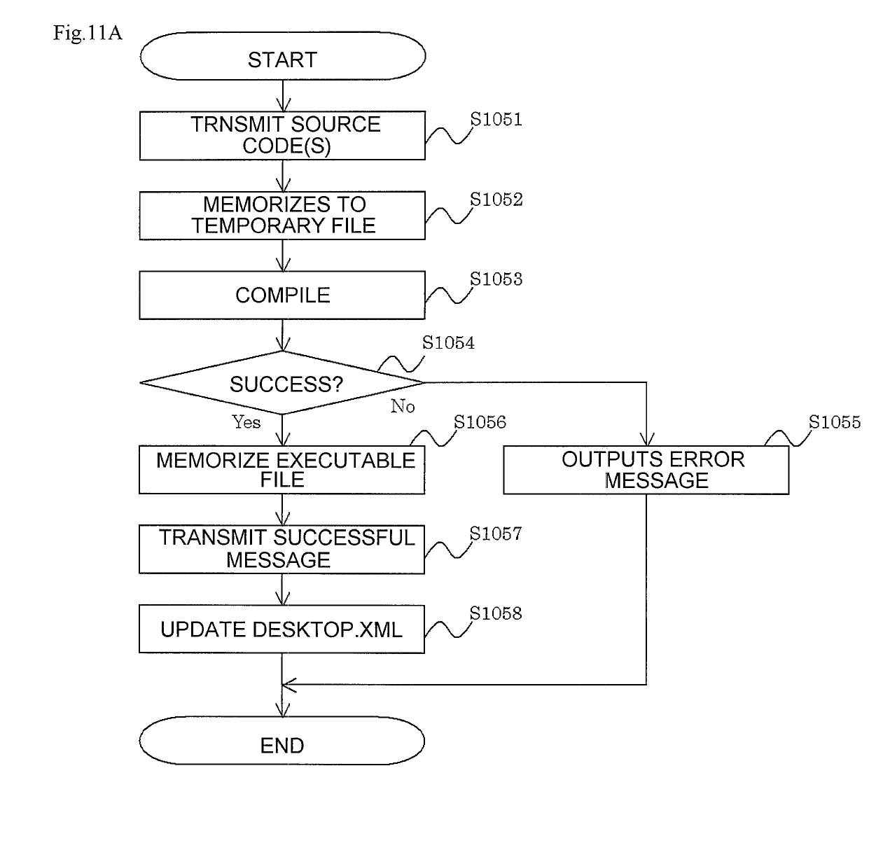

FIG. 11B is a timing chart about the compile process of the development system related to an embodiment of this invention.

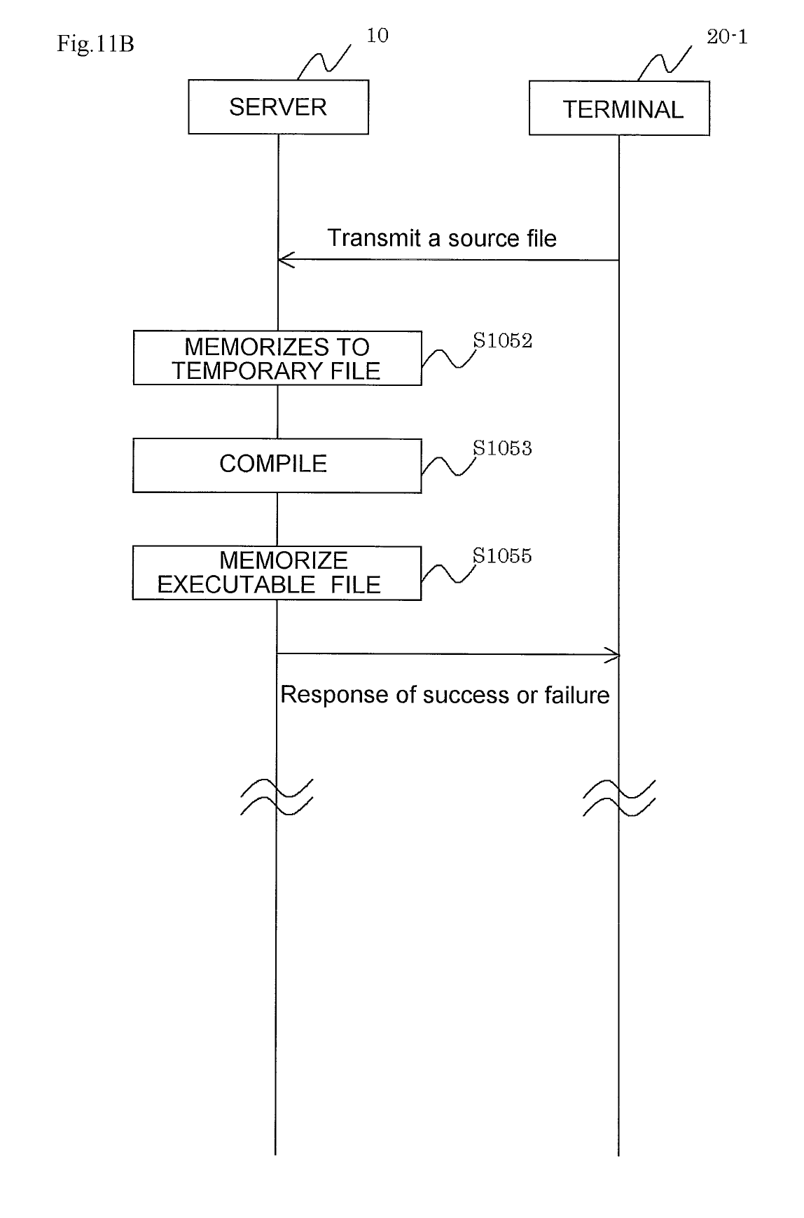

FIG. 12 is a timing chart related to the exchange of a message with software developer A of a development system and the customer B related to an embodiment of the invention.

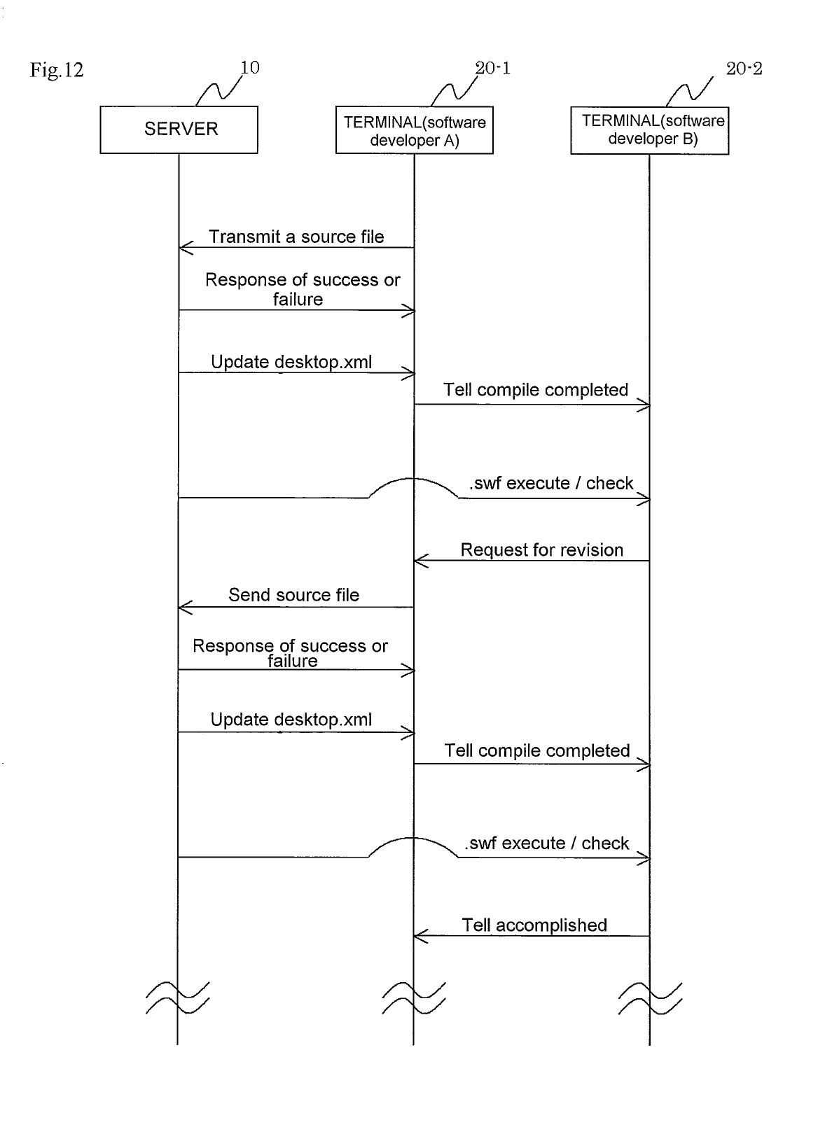

### EXPLANATION OF REFERENCE SYMBOLS

5: Network Part
10: Server
20-1-20-n: Terminal
21: Controller
22: Main Memory Part
23: Chip Set
24: Optical Disk Unit
25 Hard Disk Unit
26: Video Card
27 and 107: Network Connection Part
40: Keyboard
45: Pointing Device
50: Display
101: Controller
102: Compile Process Part
103: User Storage Part
104: Temporary File Storage Part
105: Library Binary Database
106: Library Source Database
108: User Interface Part
109: Source File Preparing Part
110: Treating Part between Users
111: Version Control Part
200: Icon
201: Menu Bar
202: Tool Bar
203: Component List
204: Panel Management Window
205: Design & Code Creation Window
206: Property Window
207: Compile Window
2050, 2051, 2052, 2053, 2061, 2062, 2064, 2065, 2071, 2072, and
2073: Tab
2063: Setting Window
3001 and 3002: Screen shot

1-10. (canceled)

11. A development system for developing software being a source program and an executable file of the source program in a server and a terminal in a network, wherein
the server having:
a library source database memorizing a general-purpose source file which is a file of a general-purpose source program,
a compiler making an executable file from a source file edited the general-purpose source file,
a network connecter transmitting and receiving the source file and the executable file between the server and the terminal, and
a source file preparer combining the general-purpose source file from a library source database; and
the terminal having:
a network connecter connecting with the server via a network, and
a integrated development environment editing and transmitting the general-purpose source file transmitted by the network connecter of the terminal from the server.

12. The development system according to claim 11, wherein
the integrated development environment includes
a source file editor for editing the general-purpose source file, and
a debugger for debugging the source file based on the executable file received from the server.

13. The development system according to claim 11, wherein
the source file includes
a common file having a process of common parts of a program,
a windowing maker having a process for making a window, and
a listeners class containing a source code had process a component in the window.

14. The development system according to claim 13, wherein
only the source code of the listeners class is correctable at the terminal.

15. The development system according to claim 11, wherein
the server further includes
a version controller managing information about renewal of the source file and the executable file.

16. The development system according to claim 11, wherein
the server further includes
a user relation processor transmitting and receiving information between the terminals having accessed the server.

17. A development system according to claim 11, wherein
The terminal further includes
an OS for thin clients processor accessing the server by an OS for thin clients.

18. A development system according to claim 11, wherein
the server further includes
a desktop screen drawer calling the executable file, and the terminal has a means to receive data from the desktop screen drawer and transmits an execute command.

19. A server of the development system developing a software being a source program and an executable file of the source program in a server and a terminal in a network, wherein
a library source database memorizing a general-purpose source file which is a file of a general-purpose source program,
a compiler making an executable file from a source file edited the general-purpose source file,
a network connecter transmitting and receiving the source file and the executable file between the server and the terminal, and
a source file preparer combining the general-purpose source file from the library source database.

20. A development method for developing software in a network server and a terminal, wherein comprising the steps of:
making a general-purpose source file by the server,
transmitting the general-purpose source file from the server to the terminal,
editing the received general-purpose source file by an integrated development environment in the terminal with making the edited source file,
transmitting the source file edited from the terminal to the server,
making an executable file by the source file edited by the server,
making a desktop screen being able to call the executable file from the terminal by the server, and
responding the call from the terminal and transmitting the desktop screen from the server to the terminal.
